(19) United States
(12) Patent Application Publication
(10) Pub. No.: US 2006/0257190 A1
(43) Pub. Date: Nov. 16, 2006

(54) Magnetically levitated key structure

(75) Inventor: Chia-Hsuan Chiang, Taipei (TW)

Correspondence Address: BIRCH STEWART KOLASCH & BIRCH, PO BOX 747, FALLS CHURCH, VA, 22040-0747, US

(73) Assignee: ASUSTeK COMPUTER INC.

(21) Appl. No.: 11/397,628

(22) Filed: Apr. 5, 2006

(30) Foreign Application Priority Data
May 13, 2005 (TW) 94115622

(51) Int. Cl. B41J 5/00

(52) U.S. Cl. 400/474

(57) ABSTRACT

A magnetically levitated key structure is disclosed. The attractive and repulsive forces of two magnetic components, which replace the elastic component of the prior key structure, control the upward and downward movement of the key cap. Therefore, the magnetically levitated key structure of the present invention has reduced key height when it is not in use, so as to minimize its occupied space.

### RELATED APPLICATIONS

The present application is based on, and claims priority from, Taiwan Application Serial Number 94115622, filed May 13, 2005, the disclosure of which is hereby incorporated by reference herein in its entirety.

### FIELD OF THE INVENTION

The present invention relates to a key structure, and more particularly, to a magnetically levitated key structure.

### BACKGROUND OF THE INVENTION

A keyboard is a kind of input device of an electronic device or a computer apparatus, of which keys are pressed to input data. When pressing these keys on the keyboard, a user uses his fingertip to contact a key cap and then to press down the key to input a datum represented by the key.

FIG. 1 is an exploded view of a conventional key structure. A key structure 100 is typically composed of a key cap 101, a supporting structure 103, a sheet 120 and a bottom plate 130 from top to bottom and along a central axis 109, wherein an elastic component 125 is set in the key cap 101 and the supporting structure 103. Pivots 131, 133 and 135 are typically set on the bottom plate 130. The sheet 120 is set on the bottom plate 130 and includes a circuit set thereon. Openings 121 are formed in the sheet 120 to expose the corresponding pivots 131, 133 and 135. The supporting structure 103, which may be composed of a first supporting frame 105 and a second supporting frame 107 intersected and pivoted with each other, is set on the sheet 120, and first ends 111 of the supporting structure 103 are pivoted at the pivots 131, 133 and 135. The key cap 101 is set on the supporting structure 103, and a bottom surface of the key cap 101 is set with pivots 113 and 115 for pivoting at second ends 112 of the supporting structure 103. The elastic component 125 is set between the sheet 120 and the key cap 101, and when the elastic component 125 is pressed, a conductive point therein contacts with an electrical contact point on the sheet 120 to input a datum represented by the key.

However, the design rule of the electronic device or the computer apparatus trends toward being more compact, but the keys of the key structure 100 have to be kept at a predetermined height due to the existence of the elastic components 125 when the keyboard of the conventional electronic device or computer, whether in use or not, thereby resulting in a design bottleneck when miniaturizing the electronic device. In addition, fatigue failure of the conventional elastic component 125 can occur after longtime use.

Therefore, what are needed in the art are key structures, which can overcome the design limitations when reducing the size of an electronic device or computer apparatus.

### SUMMARY OF THE INVENTION

The objective of the present invention is to provide a magnetically levitated key structure by using the attractive and repulsive forces between two magnetic components to control the key cap motion up and down.

According to the aforementioned objective, the present invention provides a magnetically levitated key structure. The magnetically levitated key structure comprises a first magnetic component, a supporting structure pivoted at the first magnetic component and a second magnetic component pivoted at the supporting structure. At least one first pivot is set on the first magnetic component, wherein a first end of the supporting structure is pivoted at the first pivot; and at least one second pivot of the second magnetic component is pivoted at a second end of the supporting structure. When the first magnetic component magnetically repels the second magnetic component, the second magnetic component is at a distance from the first magnetic component.

According to a preferred embodiment of the present invention, the first magnetic component comprises a permanent magnetic plate, and the second magnetic component comprises a key cap and a magnetic body. The magnetic body is of an impermanent magnet, the magnetism of which is controlled by a second electromagnetic component, such as an electromagnet.

According to another preferred embodiment of the present invention, the first magnetic component comprises an impermanent magnetic plate and a first electromagnetic component, wherein the first electromagnetic component is, for example, an electromagnet. The second magnetic component comprises a key cap of permanent magnetism, or comprises a key cap and a magnetic body. The magnetic body is composed of, for example, a permanent magnet, or the magnetism of the magnetic body is controlled by the second electromagnetic component, such as an electromagnet.

According to still another preferred embodiment of the present invention, the first magnetic component further comprises a sheet set thereon.

According to yet another preferred embodiment of the present invention, the supporting structure is composed of a supporting frame and a supporting frame intersected and pivoted with each other.

According to another preferred embodiment of the present invention, the magnetically levitated key structure is suitable for a keyboard of an electronic device or a computer.

In the application of the magnetically levitated key structure, two magnetic components, which replace the elastic component of the prior key structure, control the upward and downward motion of the key cap by using their attractive or repulsive forces with each other, so as to reduce the key height when the key is not in use, thereby greatly minimizing the space occupied by the key structure.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is an exploded view of a conventional key structure;

FIG. 2 is an exploded view of a magnetically levitated key structure in accordance with a preferred embodiment of the present invention;

FIG. 3A is a cross-sectional view of a magnetically levitated key structure when in use in accordance with a preferred embodiment of the present invention;

FIG. 3B is a cross-sectional view of a magnetically levitated key structure when not in use in accordance with a preferred embodiment of the present invention; and

FIG. 3C is a cross-sectional view of a magnetically levitated key structure in accordance with another preferred embodiment of the present invention.

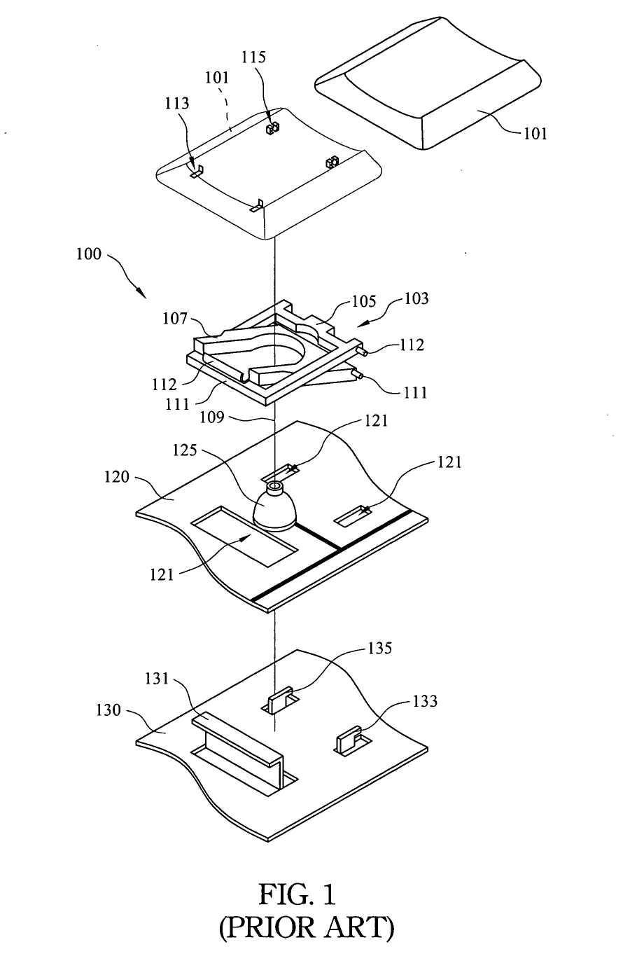

### DETAILED DESCRIPTION OF THE PREFERRED EMBODIMENT

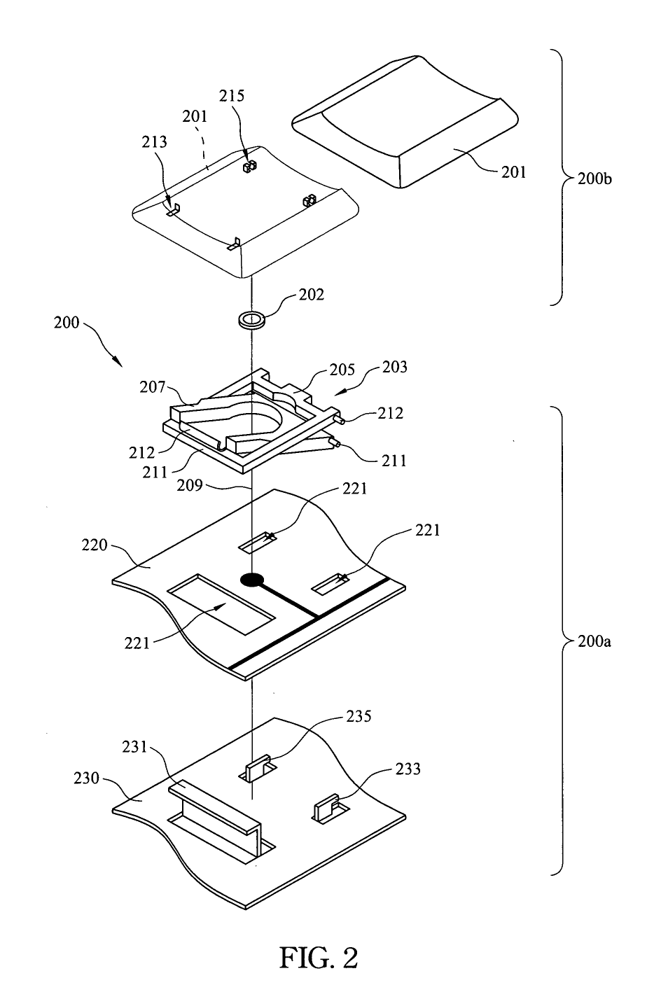

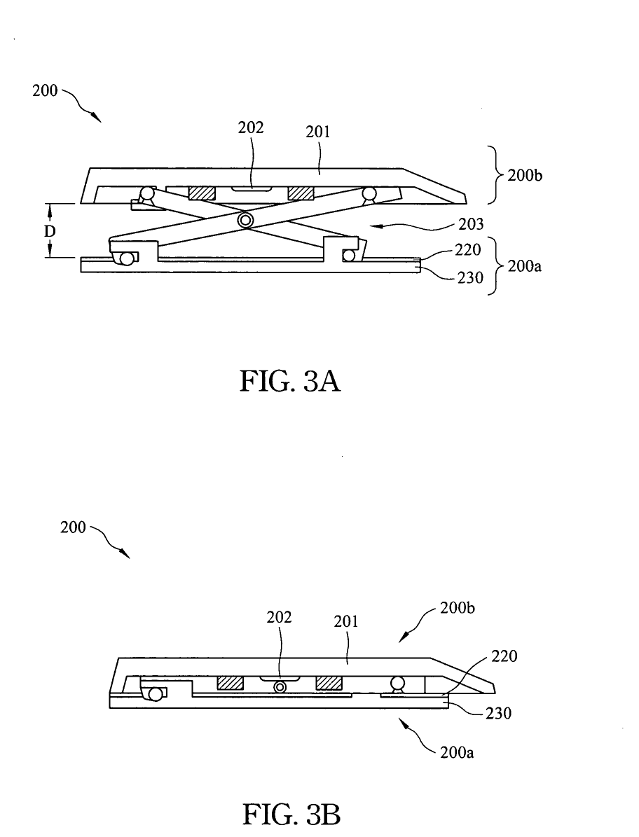

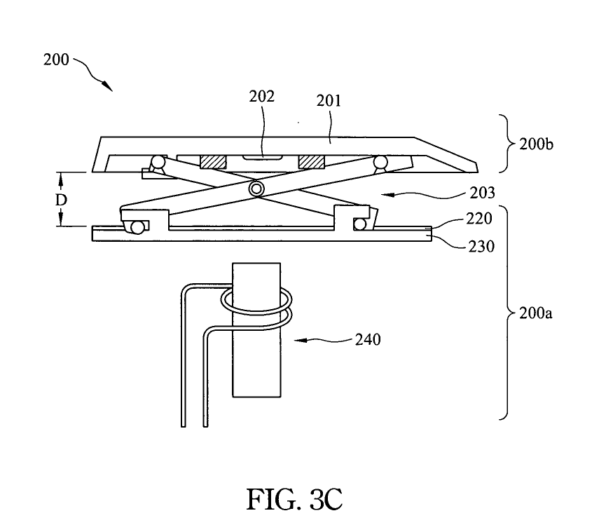

The magnetically levitated key structure of the present invention, which controls the upward and downward motion of the key cap by using the attractive and repulsive forces between two magnetic components, is suitable for a keyboard of an electronic device or a computer. Reference will now be made in detail to the preferred embodiments of the magnetically levitated key structure of the present invention, examples of which are illustrated in the accompanying drawings FIGS. 2 through 3C.

FIG. 2 is an exploded view of a magnetically levitated key structure in accordance with a preferred embodiment of the present invention. From bottom to top and along a central axis 209, a magnetically levitated key structure 200 comprises a first magnetic component 200a, a supporting structure 203 pivoted at the first magnetic component 200a, and a second magnetic component 200b pivoted at the supporting structure 203.

One feature of the magnetically levitated key structure of the present invention is to use the attractive and repulsive forces between two magnetic components to control the key cap motion up and down. In an embodiment, the first magnetic component 200a is of permanent magnetism, and the second magnetic component 200b is of impermanent magnetism. In detail, the first magnetic component 200a comprises a bottom plate 230, which is a permanent magnetic plate and is set with a plurality of first pivots 231, 233 and 235. In the embodiment, three pivots are provided, but the present invention is not limited to three. It is well known by a person skilled in the art, the first magnetic component 200a may further comprise a sheet 220 set thereon. A circuit is set in the interior of the sheet 220, and a plurality of openings 221 are formed in the sheet 220 to expose the underlying first pivots 231, 233 and 235. A supporting structure 203 is set on the first magnetic component 200a, in which the supporting structure 203 may be composed of a first supporting frame 205 and a second supporting frame 207 intersected and pivoted with each other, and first ends 211 of the supporting structure 203 are pivoted at the first pivots 231, 233 and 235. The second magnetic component 200b is set on the supporting structure 203 and comprises a key cap 201 and a magnetic body 202, wherein the magnetic body 202 may be of impermanent magnetism. The magnetism of the magnetic body 202 may be controlled by a second electromagnetic component (not shown), such as an electromagnet. A bottom surface of the key cap 201 is set with a plurality of second pivots 213 and 215 for pivoting at second ends 212 of the supporting structure 203, such as shown in FIG. 2.

FIG. 3A is a cross-sectional view of a magnetically levitated key structure while in use according to a preferred embodiment of the present invention. When the keyboard of the electronic device or computer is in use, such as when a notebook computer is opened and turned on, the aforementioned second electromagnetic component (not shown) controls the magnetism of the magnetic body 202 to make the magnetic body 202 and the bottom plate 230 (e.g. a permanent magnetic plate) repel each other. That is, the first magnetic component 200a and the second magnetic component 200b are magnetically repulsive so as to make the second magnetic component 200b be at a distance D from the first magnetic component 200a for the user to input data by the magnetically levitated key structure 200 of the present invention.

FIG. 3B is a cross-sectional view of a magnetically levitated key structure when not in use according to a preferred embodiment of the present invention. When the keyboard of the electronic device or computer is not being operated, such as when a notebook computer is closed, the aforementioned second electromagnetic component (not shown) can control the magnetism of the magnetic body 202 to make the magnetic body 202 and the bottom plate 230 (e.g. a permanent magnetic plate) attract each other. That is, the first magnetic component 200a and the second magnetic component 200b are magnetically attracted, so that the key heights of the magnetically levitated key structure 200 of the present invention can be reduced when not being used, thereby greatly decreasing the space occupied by the magnetically levitated key structure 200.

FIG. 3C is a cross-sectional view of a magnetically levitated key structure in accordance with another preferred embodiment of the present invention. The first magnetic component 200a is of impermanent magnetism, and however the second magnetic component 200b is of permanent magnetism or impermanent magnetism. In detail, the first magnetic component 200a comprises a bottom plate 230 and a first electromagnetic component 240, such as an electromagnet, wherein the bottom plate 230 is of impermanent magnetism, and the first electromagnetic component 240 is used to control the magnetism of the bottom plate 230. The bottom plate 230 includes at least one pivot set thereon, which is the same as that of the aforementioned embodiment. The first magnetic component 200a may also comprise a sheet 220 set thereon, which is the same as that of the aforementioned embodiment. A supporting structure 203 is set on the first magnetic component 200a, wherein the supporting structure 203 is the same as that of the aforementioned embodiment. The second magnetic component 200b is set on the supporting structure 203; and the second magnetic component 200b comprises a key cap 201 of permanent magnetism, or comprises a key cap 201 and a magnetic body 202, wherein the magnetic body 202 may be of permanent magnetism, or the magnetic body 202 may be of impermanent magnetism while the magnetism of the magnetic body 202 is controlled by the second electromagnetic component (not shown), such as an electromagnet. A bottom surface of the key cap 201 is set with a plurality of pivots (not shown) for pivoting on the supporting structure 203.

When the keyboard of the electronic device or computer is being used, the first electromagnetic component 240 controls the magnetism of the bottom plate 230 and causes the bottom plate 230 and the key cap 201 of permanent magnetism repel each other. That is, the first magnetic component 200a and the second magnetic component 200b are magnetically repulsive, so as to make the second magnetic component 200b be at a distance D from the first magnetic component 200a for the user to input data by the magnetically levitated key structure 200 of the present invention. In another example, the first electromagnetic component 240 can control the magnetism of the bottom plate 230 and make the bottom plate 230 and the magnetic body 202 of permanent magnetism repel each other. That is, the first magnetic component 200a and the second magnetic component 200b are magnetically repulsive, so as to make the second magnetic component 200b be at a distance D from the first magnetic component 200a. In a further example, the first electromagnetic component 240 and the second electromagnetic component (as FIG. 2) are simultaneously used to respectively control the magnetism of the first magnetic component 200a and the magnetism of the second magnetic component 200b, making the first magnetic component 200a repel the second magnetic component 200b, so as to make the second magnetic component 200b be at a distance D from the first magnetic component 200a.

The magnetically levitated key structure of the present invention uses the attractive and repulsive forces between two magnetic components, which replace the elastic component of the prior key structure, to control the upward and downward movement of the key cap. The advantages of the present invention are that the problem of elastic fatigue of the elastic component can be eliminated, and the key height when the key is not in use can be reduced, so as to greatly minimize the space occupied by the key structure.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure.

What is claimed is:

1. A magnetically levitated key structure, comprising:
a first magnetic component, wherein at least one first pivot is set on the first magnetic component;
a supporting structure, wherein a first end of the supporting structure is pivoted at the first pivot; and
a second magnetic component set on the supporting structure, and at least one second pivot of the second magnetic component is pivoted at a second end of the supporting structure;
when the first magnetic component and the second magnetic component are magnetically repulsive, the second magnetic component is at a distance D from the first magnetic component.

2. The magnetically levitated key structure according to claim 1, wherein the first magnetic component comprises a permanent magnetic plate.

3. The magnetically levitated key structure according to claim 1, wherein the second magnetic component comprises a key cap and a magnetic body.

4. The magnetically levitated key structure according to claim 3, further comprising a second electromagnetic component used to control the magnetism of the magnetic body.

5. The magnetically levitated key structure according to claim 4, wherein the second electromagnetic component is an electromagnet.

6. The magnetically levitated key structure according to claim 1, wherein the first magnetic component comprises a bottom plate and a first electromagnetic component.

7. The magnetically levitated key structure according to claim 6, wherein the first electromagnetic component is an electromagnet.

8. The magnetically levitated key structure according to claim 1, wherein the second magnetic component comprises a permanent magnetic key cap.

9. The magnetically levitated key structure according to claim 1, wherein the second magnetic component comprises a key cap and a magnetic body.

10. The magnetically levitated key structure according to claim 9, wherein the magnetic body is of permanent magnetism.

11. The magnetically levitated key structure according to claim 9, further comprising a second electromagnetic component used to control the magnetism of the magnetic body.

12. The magnetically levitated key structure according to claim 11, wherein the second electromagnetic component is an electromagnet.

13. The magnetically levitated key structure according to claim 1, further comprising a sheet set on the first magnetic component.

14. The magnetically levitated key structure according to claim 1, wherein the supporting structure is composed of a first supporting frame and a second supporting frame intersected and pivoted with each other

15. The magnetically levitated key structure according to claim 1, wherein the magnetically levitated key structure is suited to a keyboard of an electronic device.

16. The magnetically levitated key structure according to claim 1, wherein the magnetically levitated key structure is suited to a computer keyboard.
